(19) United States
(12) Patent Application Publication
(10) Pub. No.: US 2016/0191375 A1
(43) Pub. Date: Jun. 30, 2016

(54) ENHANCED UPLINK CHANNEL CONTROL FOR USER EQUIPMENT BASED ON THE CHANNEL CONDITION OF ENHANCED UPLINK CAPABLE CELL(S)

(71) Applicant: QUALCOMM Incorporated, San Diego, CA (US)

(72) Inventors: Rajesh GOPALA KRISHNAN, Hyderabad (IN); Sitaramanjaneyulu Kanamarlapudi, San Diego, CA (US); Guruvayurappan Vasudevan, Hyderabad (IN)

(21) Appl. No.: 14/800,372

(22) Filed: Jul. 15, 2015

Related U.S. Application Data
(60) Provisional application No. 62/097,516, filed on Dec. 29, 2014.

(51) Int. Cl. H04L 12/707; H04W 72/12; H04W 36/00; H04W 76/06

(52) U.S. Cl. CPC H04L 45/22; H04W 76/06; H04W 72/1284; H04W 36/0055

(57) ABSTRACT

Aspects of controlling uplink transmissions on an enhanced dedicated channel in wireless communications include a user equipment configured to determine an unfavorable condition of an enhanced dedicated channel established with an enhanced network entity in response to failing to receive a threshold number of responses corresponding to uplink data transmissions on the enhanced dedicated channel, during an established connection with at least one non-enhanced network entity. Further, the aspects may include the UE suspending building of protocol data units for enhanced dedicated channel transmissions in response to determining the unfavorable condition of the enhanced dedicated channel. Additionally, the aspects may include the UE suspending uplink transmission on the enhanced dedicated channel in response to determining the unfavorable condition of the enhanced dedicated channel.

### CLAIM OF PRIORITY UNDER 35 U.S.C. §119

The present application for patent claims the benefit of Provisional Application No. 62/097,516, filed Dec. 29, 2014, which is assigned to the assignee hereof and hereby expressly incorporated in its entirety by reference herein.

### BACKGROUND

Aspects of the present disclosure relate generally to wireless communication systems, and more particularly, to control of a dedicated channel on uplink transmissions.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA) and High Speed Uplink Packet Access (HSUPA), which provide higher data transfer speeds and capacity to associated UMTS networks.

Wireless communication system operators implementing the later evolution 3GPP systems (e.g., HSUPA) typically also maintain legacy systems (e.g., Release 99 W-CDMA) to accommodate users having legacy devices and/or as a fall back system for high speed enhanced devices experiencing failure conditions on the high speed enhanced transmissions. An active set of cells associated with a user equipment (UE) may include a combination of legacy or non-enhanced base stations (e.g., NodeBs) and enhanced base stations (e.g., eNodeBs) for mobility support (e.g., soft handover) of the UE. A base station that sends an absolute grant to a UE belongs to a serving cell for the UE. Other base stations in the surrounding vicinity of the UE may be included in an active set from which the UE may handover a current call (e.g., if the UE moves away from the serving cell).

In some scenarios, the UE may initiate and maintain uplink transmissions on an enhanced dedicated channel (e.g., E-DCH) with an enhanced base station in response to favorable measurements of downlink dedicated physical channel (DL DPCH) from a legacy or non-enhanced (e.g., Release 99) base station. The UE estimates a quality of a downlink dedicated physical control channel over time and sends an indication to higher layers that the UE is “in-sync” if the measurements are favorable, or “out-of-sync” if the quality is below an satisfactory level. For example, the UE may determine synchronization primitives associated with non-enhanced or legacy (e.g., Release 99) base station and send such synchronization messages based on established specifications, such as based on 3GPP Technical Specification (TS) 25.214 and TS 25.319. For instance, in CELL_FACH state, an E-DCH active set of the UE contains only the serving E-DCH cell, while in CELL DCH state, the UE can have zero, one or several non-serving E-DCH radio links. In this case, for example, the UE may assume there is a reciprocal quality between uplink and downlink channels even though the respective channels are established with different base stations.

In such a case where the UE has a strong DL DPCH (e.g., with a legacy network entity) but includes an active set where all available (which may be only one) enhanced network entities (e.g., eNodeBs) capable of receiving enhanced dedicated channel uplink transmissions have an enhanced uplink dedicated channel suffering from a degraded quality condition, the uplink enhanced dedicated channel transmissions from the UE may be failing due to the poor signal quality condition. Such a scenario may lead to missed receipt of and/or improperly decoded transmissions (including, e.g., hybrid automatic repeat requests (HARQ)) at the enhanced network entity. Further, in this situation, the UE likely transmits the transmission and/or retransmission at a high transmit power in an attempt to overcome the failing channel conditions, which increases thermal noise for uplink transmissions in the cell, and also results in interference to uplink transmissions by other UEs.

Another example scenario in which the UE may be caught transmitting on a weak enhanced uplink dedicated channel is where the UE is enabled for post verification during synchronization. If a signaling radio bearer (SRB) is mapped to an enhanced network entity of the serving cell and UE measurements of enhanced downlink transmissions indicates acceptable channel conditions, the UE may proceed with enhanced uplink transmissions while performing post verification to confirm that the enhanced uplink channel is functioning properly, under the presumption that the condition of the enhanced uplink channel is equal to the condition of the enhanced downlink channel. However, the enhanced uplink channel may actually be weak, resulting in ineffective uplink transmissions during the post verification period.

Another example leading to similar issues with enhanced uplink transmissions may be a UE (e.g., a dual SIM dual standby (DSDS) UE) performing a tune away between the weak enhanced serving cell and the strong legacy cell. When tuning back to the enhanced serving cell, the UE may be out-of sync, but will continue to transmit on the enhanced uplink dedicated channel for some time based on favorable measurements of the legacy cell before the issue is recognized regarding the poor conditions of the enhanced serving cell, risking loss of the radio link with the legacy cell to re-establish the connection to the enhanced cell.

Thus, improvements in control of uplink transmissions on an enhanced dedicated channel are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, the disclosure relates to a UE, which is able to perform wireless communications with both a legacy (e.g., Release 99) base station or cell as well as an enhanced base station or cell, controlling uplink transmissions on an enhanced dedicated channel.

For instance, in an aspect, this disclosure provides a method of a user equipment controlling uplink transmissions on an enhanced dedicated channel in wireless communications, including determining an unfavorable condition of an enhanced dedicated channel established with an enhanced network entity in response to failing to receive a response corresponding to transmissions on the enhanced dedicated channel, wherein a number of failed responses exceeds a threshold, during an established connection with at least one legacy network entity. Further, the method includes suspending building of protocol data units for enhanced dedicated channel transmissions in response to determining the unfavorable condition of the enhanced dedicated channel, and suspending uplink transmission on the enhanced dedicated channel in response to determining the unfavorable condition of the enhanced dedicated channel.

In another aspect, the disclosure provides for a user equipment for controlling uplink transmissions on an enhanced dedicated channel in wireless communications, including a transceiver configured to transmit uplink data transmissions on the enhanced dedicated channel, and to receive responses corresponding to the uplink data transmissions, and at least one processor coupled to the transceiver via a bus. The at least one processor is configured to determine an unfavorable condition of the enhanced dedicated channel in response to failing to receive a response corresponding to the uplink data transmissions on the enhanced dedicated channel, wherein a number of failed responses exceeds a threshold, during an established connection with at least one legacy network entity. Also, at least one processor is configured to suspend building of protocol data units for enhanced dedicated channel transmissions in response to determining the unfavorable condition of the enhanced dedicated channel. Additionally, at least one processor is configured to suspend the uplink data transmissions by the transceiver on the enhanced dedicated channel, in response to determining the unfavorable condition of the enhanced dedicated channel.

In another aspect, the disclosure provides for a computer-readable medium storing computer executable code for controlling uplink transmissions on an enhanced dedicated channel in wireless communications, including code for determining an unfavorable condition of an enhanced dedicated channel in response to failing to receive a response corresponding to transmissions on the enhanced dedicated channel, wherein a number of failed responses exceeds a threshold, during an established connection with at least one legacy network entity, code for suspending building of protocol data units for enhanced dedicated channel transmissions in response to determining the unfavorable condition of the enhanced dedicated channel, and code for suspending uplink transmission on the enhanced dedicated channel in response to determining the unfavorable condition of the enhanced dedicated channel.

These and other aspects of the disclosure will become more fully understood upon a review of the detailed description, which follows.

### BRIEF DESCRIPTION OF THE DRAWINGS

The accompanying drawings are presented to aid in the description of various aspects of the disclosure and are provided solely for illustration of the aspects and not limitation thereof. The drawings include like reference numbers for like elements, and may represent optional components or actions using dashed lines.

FIG. 1 is a block diagram illustrating an example communications network including network entities, such as legacy and enhanced base stations, in communication with a user equipment (UE) configured for management of uplink transmission on an enhanced dedicated channel.

FIG. 2 is a block diagram conceptually illustrating architectural components of an example of an implementation of the user equipment of FIG. 1.

FIG. 3 is a flow diagram illustrating an example method of managing uplink transmission on the enhanced dedicated channel, as may be performed by the UE of FIG. 1.

FIG. 4 is a signal and state diagram illustrating an example communication exchange between the UE and network entities of FIG. 1 with respect to UE management of uplink transmissions on the enhanced dedicated channel.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware, firmware, and/or software, and may be divided into other components.

The present disclosure provides for user equipment (UE) control of uplink transmissions on an enhanced dedicated channel (e.g., an uplink E-DCH). In a network having a user equipment (UE) enabled to send and receive high speed enhanced data packets on an enhanced dedicated channel provided by an enhanced Node B (eNodeB), prior solutions may allow the UE to persist in transmitting or retransmitting uplink signals at high power on the enhanced dedicated channel despite bad channel conditions. For example, the prior solutions may allow repeated transmissions/retransmission despite repeated lack of receiving responses to prior transmissions or retransmissions (in other words, despite repeated unacknowledged transmissions such as transmissions lacking receipt of an acknowledgement (ACK) or a not acknowledged (NAK) message) and/or despite repeated decoding errors in received acknowledgement messages (e.g., received on the E-DCH Hybrid Automatic Repeat Request (ARQ) Indicator Channel (E-HICH)). As such, the prior solutions may cause the UE to unnecessarily lose battery and also to cause a rise in thermal noise and/or interference in the network. The present aspects allow the UE to intervene and autonomously cease building the respective uplink data packets, and cease the corresponding uplink transmissions on the enhanced dedicated channel. For example, the UE may cease such activities until a different eNodeB with more favorable channel conditions is added to the active set and becomes available for handover, or until the channel conditions improve enough with the serving eNodeB to allow the UE to resume uplink transmissions.

For example, in an aspect, the UE may be configured with a multi-SIM capability, and while a first connection with a legacy network entity may be established, the UE detects an unfavorable condition of an enhanced dedicated channel associated with a second connection with an enhanced network entity based on identifying that a number of unacknowledged transmissions has reached an unacknowledged transmission threshold. An unacknowledged transmission, as used herein, may refer to one or more of an uplink E-DCH transmission for which no response is received, or an uplink E-DCH transmission for which a NAK message is received, or an uplink E-DCH transmission for which a response (e.g., ACK message) is received but is not able to be properly decoded (e.g., fails cyclic redundancy check). For example, the UE may determine the unfavorable condition when a number of consecutive unacknowledged HARQ transmissions on the E-DCH meets a value of the unacknowledged transmission threshold. In response to detecting the unfavorable condition of the enhanced dedicated channel, in one optional aspect, the UE may suspend building protocol data units (PDUs) for enhanced dedicated channel transmissions, and in another optional or additional aspect, the UE may suspend transmissions on the enhanced dedicated channel. If the unfavorable condition of the enhanced dedicated channel has a duration that meets an unfavorable condition threshold (which may be a time period shorter than duration of a network-based RLC reset timer at the eNodeB), the UE may send a signaling connection release indicator (SCRI) to the network to trigger a release of the connection to the serving eNodeB for the enhanced dedicated channel. In an aspect, a duration corresponding to the value of the unacknowledged transmission threshold is less than the duration corresponding to the unfavorable condition threshold.

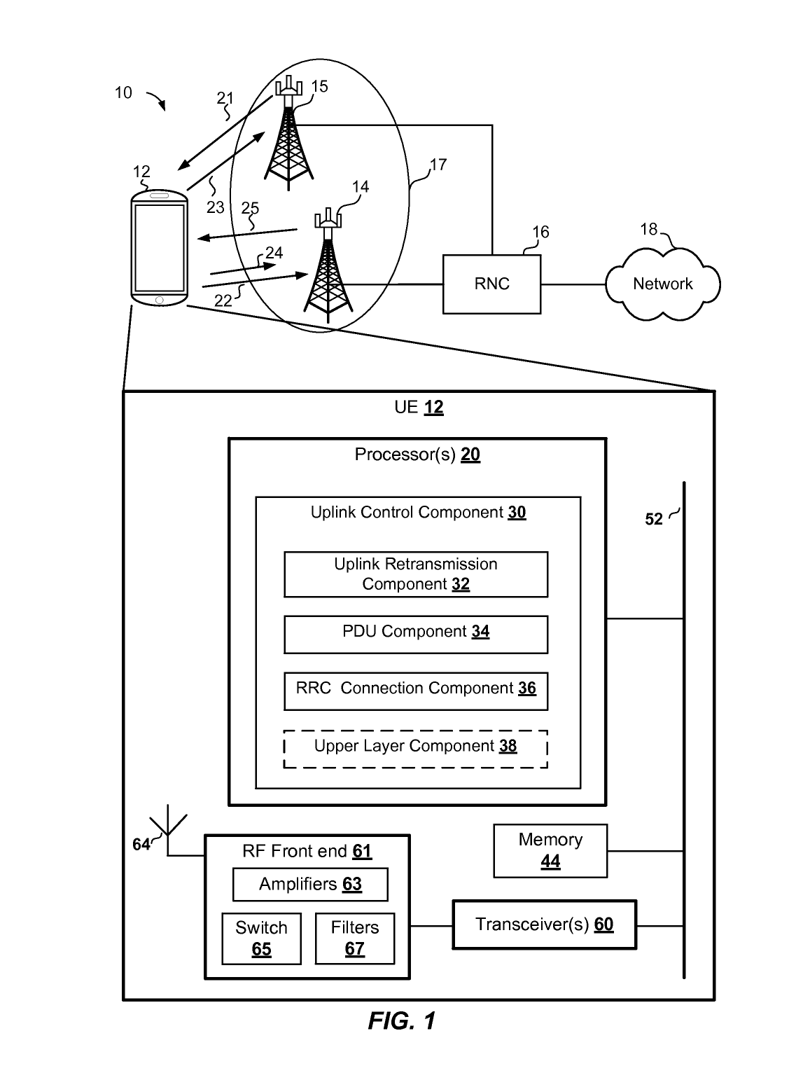

Referring to FIG. 1, in an aspect, a wireless communication system 10 includes UE 12 in communication coverage of at least one enhanced network entity 14 (e.g., enhanced network entity or enhanced node B (eNodeB or eNB)) and at least one non-enhanced network entity 15. For instance, in a UMTS network, the non-enhanced network entity 15 may be a Release 99 (e.g., R99) or earlier base station, also known as a “legacy” base station, whereas the enhanced network entity 14 may be release more recent than R99. As such, the UE 12 may have an active set 17 that includes the at least one enhanced network entity 14 and the at least one non-enhanced network entity 15. While only one enhanced network entity 14 and one non-enhanced network entity 15 are shown in FIG. 1, the active set 17 may include additional network entities, either enhanced or non-enhanced (such as, but not limited to, an active set of up to 6 network entities, and an E-DCH active set of up to 4 network entities). UE 12 may communicate in a multi-carrier session with a network 18 via enhanced network entity 14 and non-enhanced network entity 15, and a radio network controller (RNC) 16. In an alternative aspect, UE 12 may communicate in a single-carrier session with a network 18 via enhanced network entity 14 and non-enhanced network entity 15, and a radio network controller (RNC) 16.

In an aspect, UE 12 may establish a connection with non-enhanced network entity 15, the connection having an uplink channel 23 (e.g., uplink dedicated physical data channel (DPDCH) and dedicated physical control channel (DPCCH)) and a downlink channel 21 (e.g., downlink dedicated physical channel (DL DPCH), such as dedicated physical data channel (DPDCH) and/or dedicated physical control channel (DPCCH)). Further, UE 12 may have determined that uplink channel 23 and downlink channel 21 are synchronized and sufficient for communications. Also, in an aspect, UE 12 may have additionally established a connection with enhanced network entity 14, the connection having an enhanced dedicated channel, shown as enhanced uplink channel 22, such as an enhanced DPDCH (E-DPDCH) and/or an enhanced DPCCH (E-DPCCH), for sending transmissions 24 to enhanced network entity 14, and an enhanced downlink channel 25 for receiving responses to such transmissions and/or control signaling. In an aspect, the enhanced uplink channel 22 may carry more data and/or may carry data more quickly than uplink channel 23. UE 12 may determine that enhanced uplink channel 22 is synchronized and sufficient for communications based on the determination that uplink channel 23 and downlink channel 21 with non-enhanced network entity 15 are synchronized and sufficient for communications, even though the channel conditions may differ from those of enhanced uplink channel 22. For example, in the UMTS protocol, the current enhanced dedicated channel transmission is based on the DL DPCH synchronization primitives with the non-enhanced network entity 15 as per 3GPP TS 25.214. For instance, UE 12 estimates the DPCCH quality over a previous time period and indicates downlink synchronization or out of synchronization to higher protocol layers, and uplink synchronization may be established through power control preamble (PCP) and signaling radio bearer (SRB) delays to ensure uplink transmissions. In such a case, only one synchronization status indication may be given per radio link set.

According to the present aspects, the UE 12 may include one or more processors 20 coupled to a memory 44 and transceiver 60 via a bus 52. One or more processors 20 may execute various components for controlling uplink data transmission on an enhanced dedicated channel as described herein. For instance, in some aspects, the various components related to controlling uplink data transmission on an enhanced dedicated channel may be executed by a single processor, while in other aspects different ones of the components may be executed by a combination of two or more different processors. For example, in an aspect, the one or more processors 20 may include any one or any combination of a modem baseband processor, or a digital signal processor, or a transmit processor, or a transceiver processor. In particular, the one or more processors 20 may execute an uplink control component 30 configured control uplink transmissions (including retransmissions) 24 on enhanced uplink channel 22 based on the status of responses regarding the receipt of such uplink transmissions (including retransmissions) by enhanced network entity 14. In an aspect, the uplink control component 30 may include processor hardware and/or software code executable by a processor for controlling uplink transmissions (including retransmissions) on enhanced uplink channel 22, which is a dedicated channel, such as E-DPDCH and/or E-DPCCH. The uplink control component 30 may be configured to determine an unfavorable condition of enhanced uplink channel 22 based on unacknowledged transmissions on enhanced uplink channel 22, e.g., based on a lack of response or negative acknowledgements, or undecodable acknowledgements from enhanced network entity 14 with respect to transmissions 24. For example, in an aspect, uplink control component 30 may be configured to determine the unfavorable condition of enhanced uplink channel 22 based on identifying that a threshold number of unacknowledged transmissions (e.g., original transmissions or HARQ retransmissions) has occurred. In some aspects, the threshold number of unacknowledged transmissions may be a threshold number of consecutive unacknowledged retransmissions (e.g., unacknowledged HARQ transmissions). In other words, when the UE 12 does not receive an ACK, or receives a NAK, in response to the transmissions/retransmissions for a threshold number of consecutive transmissions/retransmissions, or is otherwise unable to decode a received response to a transmission/retransmission, then the UE 12 can assume that the enhanced network entity 14 is not receiving the transmission/retransmissions, and hence that the condition of enhanced uplink channel 22 is unfavorable, or that the condition of enhanced downlink channel 25 is unfavorable. In either case, the functioning of enhanced uplink channel 22 will not be proper and the UE 12 will be wasting resources. As such, uplink control component 30 may stop building PDUs for transmission on enhanced uplink channel 22, and/or may stop all transmissions (including retransmissions) on enhanced uplink channel 22. Further, if uplink control component 30 determines that the unfavorable condition of enhanced uplink channel 22 persists for a duration of time that meets an unfavorable condition threshold, then uplink control component 30 may be configured to trigger a release of enhanced uplink channel 22. For instance, in an aspect, uplink control component 30 may be configured to send a connection release indicator for the enhanced dedicated channel to the enhanced network entity 14 in response to determining the duration has reached the unfavorable condition threshold. As such, the UE 12 may then attempt to re-establish the enhanced uplink channel.

In operation, for example, in the case of UE 12 in communication with enhanced network entity 14, the UE 12 may have a protocol data unit (PDU) component 34 for building and encoding data in a protocol data unit (PDU) for transport on enhanced uplink channel 22 to enhanced network entity 14. If the transmissions 24 including such data are not acknowledged in a certain amount of time by the enhanced network entity 14, then the UE 12 may resend the transmission to enhanced network entity 14 in a retransmission (e.g., a HARQ retransmission) controlled by an uplink retransmission component 32. In an aspect, a HARQ failure may occur at enhanced network entity 14 due to failure to decode the uplink transmissions/retransmissions. In the same aspect or in additional aspects, HARQ acknowledgment indications from enhanced network entity 14 may fail to arrive at UE 12, or may be received by may not be able to be decoded, if the enhanced downlink channel 25 is experiencing poor channel conditions. In an aspect, for example, uplink control component 30 at UE 12 may be configured to determine the unfavorable condition of enhanced uplink channel 22 and/or enhanced downlink channel 25 in response to a failure to receive a response (e.g., HARQ acknowledgment indications) or being unable to decode a received response to a threshold number of consecutive retransmissions, thereby triggering the stopping of building of PDUs and/or the stopping of transmissions 24 (including retransmissions) on enhanced uplink channel 22. Further, upon determining that the unfavorable condition of enhanced uplink channel 22 and/or enhanced downlink channel 25 persists for a duration of time that meets the unfavorable condition threshold, the UE 12 may include a radio resource control (RRC) connection component 36 for sending a signaling connection release indication (SCRI) to enhanced network entity 14 to release the connection so that the UE 12 may attempt to re-establish enhanced uplink channel 22 with another network entity.

In an aspect, the uplink retransmission component 32 may include hardware and/or software code executable by a processor to determine whether responses corresponding to transmissions or retransmissions on the enhanced uplink channel 22 have been received, and if not, for executing one or more HARQ retransmission processes. For example, uplink retransmission component 32 may help to determine an unfavorable condition based on identifying that a number of unacknowledged transmissions meets an unacknowledged transmission threshold, such as but not limited to identifying failure to receive a response to a threshold number of continuous uplink retransmissions on enhanced uplink channel 22. Moreover, uplink retransmission component 32 may determine that receipt of and/or decoding of retransmissions has failed for the unfavorable condition threshold (e.g., a defined duration, an interval of n transmission time intervals (TTIs), where n is a positive integer that has a value that may vary depending on implementation). Uplink retransmission component 32 may communicate with uplink control component 30 to share information and to help determine an unfavorable condition of enhanced uplink channel 22.

In an aspect, the PDU component 34 may include hardware and/or software code executable by a processor for building PDUs for each uplink transmission on a layer 2/layer 1 transport channel. For example, if the UE 12 is linked with enhanced network entity 14 enabled to receive high speed/enhanced uplink transmissions, the PDU component 34 may build transport layer PDUs for transport on an enhanced dedicated channel (E-DCH). Alternatively, or in addition, a PDU component 34 may build physical layer PDUs for transport on an enhanced dedicated physical channel (e.g., E-DPDCH and/or E-DPCCH). In a further aspect, PDU component 34 may further suspend PDU building for enhanced dedicated channel transmissions in response to a determination that an unfavorable condition on enhanced dedicated channel is present.

In an aspect, the RRC connection component 36 may include hardware and/or software code executable by a processor for generating a signaling connection release indicator for suspending uplink transmissions to the enhanced network entity 14 in response to a determination that decoding of retransmissions has failed for the unfavorable condition threshold (e.g., an interval of n transmission time intervals (TTIs). For example, if uplink retransmission component 32 determines that retransmissions on the uplink dedicated channel for sending uplink control signaling have been failing for a defined duration (e.g., n TTIs), the RRC connection component 36 may determine that the radio link with the enhanced network entity 14 should be terminated and may subsequently release the connection to the enhanced dedicated channel.

In an optional aspect, upper layer component 38 may include hardware and/or software code executable by a processor for detecting a new network entity in the active set 17, and then executing a handover to the new network entity so that an enhanced dedicated channel can be established for resuming uplink transmissions by the uplink retransmission component 32 in the case where the enhanced uplink channel 22 was released with enhanced network entity 14.

As a result of the present aspects, UE 12 may suspend what are likely to be high power uplink transmissions on a weak enhanced dedicated channel, thereby preserving battery resources and reducing thermal noise generated by the repeated transmissions and/or retransmissions. In addition, by suspending PDU building and/or suspending uplink transmissions, and/or releasing the link to the enhanced dedicated channel, an established connection (e.g., to a non-enhanced network entity) is not compromised due to a potential radio link failure on the enhanced dedicated channel.

Moreover, in an aspect, UE 12 may include one or more transceivers 60 for receiving and transmitting radio transmissions. For instance, the one or more transceivers 60 may be configured to receive different kinds of radio signals, e.g., cellular, WiFi, Bluetooth, GPS, etc. For example, in an aspect, one or more transceivers 60 may be in communication with or connected to a radio frequency (RF) front end 61 defined by, for instance one or more power amplifiers 63, one or more band specific filters 67, and one or more antennas 64. When a downlink signal is received by UE 12, such as but not limited to acknowledgement message in response to an uplink transmission, antenna 64 converts radio waves of the received signal to an electrical signal. Antenna switch 65 may be a duplex switch that may selectively operate to select either a transmit path or a receive path for the signal (e.g., to select a receive path in this example). Filters 67 perform frequency filtering on the signal to obtain the desired frequency band. One or more transceivers 60 may perform a downconversion of the received signal from RF front end 61, and may split the signal into in-phase and quadrature (I and Q) components. Amplifiers 63 may include a first amplifier to boost the filtered signal initially received from filters 67, and a second amplifier for boosting the I and Q components. The I and Q components may then be converted to a digital format and demodulated by transceiver 60. The I and Q components of received signal leaving one or more transceivers 60 may be a baseband signal that may be then further processed by the at least one processor 20. Although one or more transceivers 60 is shown as a separate component from one or more processors 20, it should be understood that in some implementations, one or more transceivers 60 may be included as a part of one or more processors 20.

For example, one or more transceivers 60 may include a transmitter and may include hardware and/or software code executable by one or more processors 20 for transmitting HARQ transmissions and retransmissions. Additionally, for example, transceiver 60 may also include a receiver for receiving ACK or NAK transmissions from enhanced network entity 14 in response to the HARQ transmissions. One or more transceivers 60 may also transmit data on the enhanced dedicated channel via a transmitter according to the suspended and resumed state of the enhanced dedicated channel according to the aspects described herein. One or more transceivers 60 may also transmit a signaling connection release indicator (SCRI) message via a transmitter to enhanced network entity 14 to trigger a release from the connection to enhanced network entity 14 in response to an unfavorable condition on the enhanced dedicated channel, such as but not limited to a condition of a threshold number of consecutive unacknowledged HARQ transmissions being reached, or such as a time period associated with a number of unacknowledged HARQ transmissions lasting longer than a threshold duration (e.g., a threshold duration of n TTIs (where n can be any positive number)).

In some aspects, UE 12 may also be referred to by those skilled in the art (as well as interchangeably herein) as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. A UE 12 may be a cellular phone, a personal digital assistant (PDA), a wireless modem, a wireless communication device, a handheld device, a tablet computer, a laptop computer, a cordless phone, a wireless local loop (WLL) station, a global positioning system (GPS) device, a multimedia device, a video device, a digital audio player (e.g., MP3 player), a camera, a game console, a wearable computing device (e.g., a smart-watch, smart-glasses, a health or fitness tracker, etc), an appliance, a sensor, a vehicle communication system, a medical device, a vending machine, a device for the Internet-of-Things, or any other similar functioning device. Additionally, enhanced network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

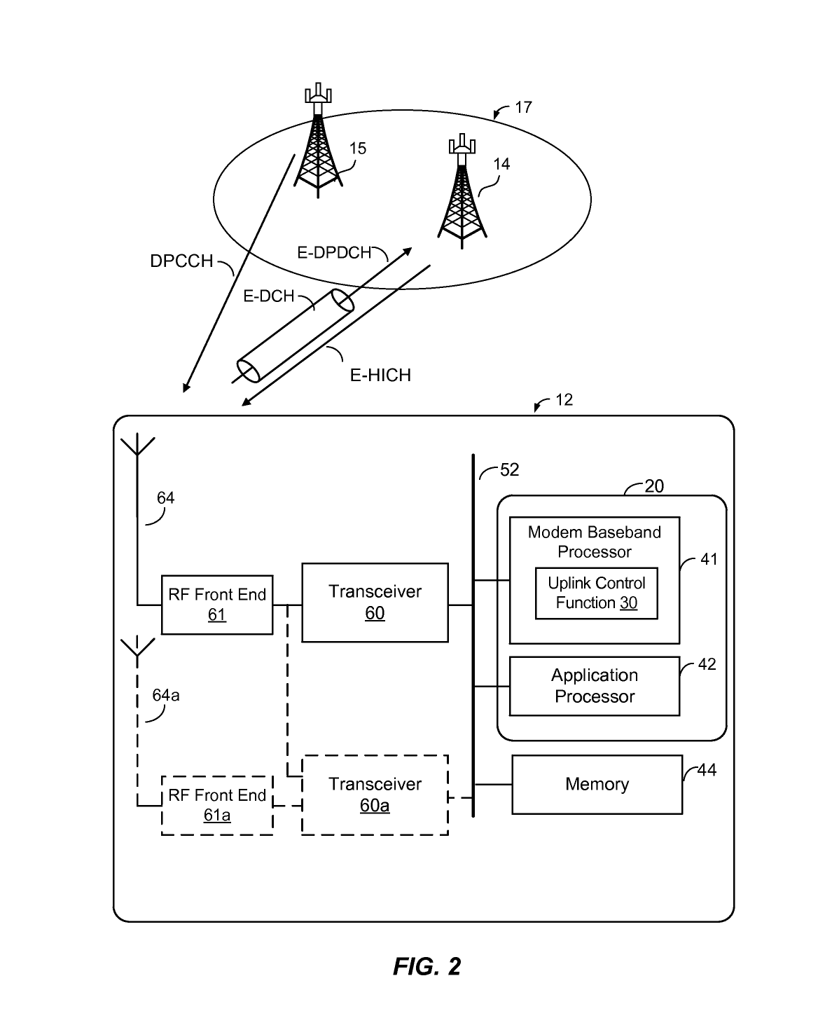

Referring to FIG. 2, in one example that should not be construed as limiting, the aspects of uplink control component 30 described herein may be executed by one or a combination of processors of UE 12, such as a modem baseband processor 41. Accordingly, in one implementation, the one or more processors 20 of FIG. 1 may include a modem baseband processor 41 and an application processor 42. As an example, modem baseband processor 41 may perform the digital processing for the radio signals transmitted and received by one or more transceivers 60 while application processor 42 is the main processor for UE 12 for controlling user interface functions or other application being executed by UE 12. In an optional aspect, UE 12 may include a second transceiver 60a for separately transmitting and receiving signals on the physical uplink and downlink channels with a second network entity. For example, transceiver 60 may transmit and receive physical channels corresponding to a first connection with non-enhanced network entity 15, and transceiver 60a may transmit and receive signals on the physical channels for a second connection with network entity 14. In another optional aspect, a second RF front end 61a may transmit and receive RF signals for the second network entity 14 via a separate antenna 64a.

In an example, communications may be exchanged between enhanced network entity 14 and UE 12, and non-enhanced network entity 15 and UE 12, starting first with a downlink communication. With non-enhanced network entity 15 (e.g., R99 base station) operating as the serving cell, modem baseband processor 41 may establish a physical dedicated channel from received downlink synchronization primitives on a downlink physical control channel (DPCCH) transmitted by non-enhanced network entity 15. Modem baseband processor 41 may estimate the channel quality of the DPCCH received from RF front end 61, compare the estimated quality to one or more quality thresholds, and if the quality meets or exceeds a threshold, an in-sync condition may be determined. Modem baseband processor 41 may also establish an enhanced session with enhanced network entity 14, and may apply a HARQ scheme on an enhanced dedicated channel (E-DCH). A HARQ component running in enhanced network entity 14 (not shown) may receive uplink data transmissions from UE 12 via an enhanced DPDCH (E-DPDCH) of the E-DCH, attempt to decode the data, and send HARQ feedback indication signals on the enhanced hybrid indicator channel (E-HICH). For example, the HARQ feedback indication signals may include ACK or NAK messages, respectively indicating that uplink retransmissions on E-DPCCH have or have not been decoded properly at the enhanced network entity 14. Further, for example when channel conditions associated with E-DCH are of a quality that is below a quality threshold, the HARQ feedback indication signals transmitted by enhanced network entity 14 may not be received by UE 12, or may not be properly received and thus may not be able to be decoded, thereby resulting in an unacknowledged transmission. Further, for example when channel conditions associated with E-DCH are of a quality that is below a quality threshold, the uplink data transmissions from UE 12, and thus enhanced network entity 14 may not send any HARQ feedback indication signals, thereby resulting in an unacknowledged transmission. As such, uplink control component 30 may be executed by modem baseband processor 41 to detect that a number or count of unacknowledged HARQ transmissions (e.g., retransmission failures) have reached a defined threshold, or that a threshold duration of n TTIs (where n can be any positive number) has expired, indicating that the uplink E-DPCCH is in an unfavorable condition. According to an aspect, the defined threshold for the count of unacknowledged HARQ transmissions and/or for the duration of n TTIs may be stored in memory 44.

In an aspect, uplink control component 30 then may be executed by modem baseband processor 41 to suspend building PDUs for transmission on E-DPCCH in response to a determination that an unfavorable condition exists on E-DPCH. Moreover, uplink control component 30 may be executed by modem baseband processor 41 to suspend uplink transmission on the E-DPCCH in response to determining the unfavorable condition. As such, UE 12 may avoid wasting resources in an attempt to send uplink transmissions that may not be received, or received correctly, by enhanced network entity 14 due to the unfavorable channel conditions (despite seemingly being in sync based on downlink measurements of the DPCCH from non-enhanced network entity 15).

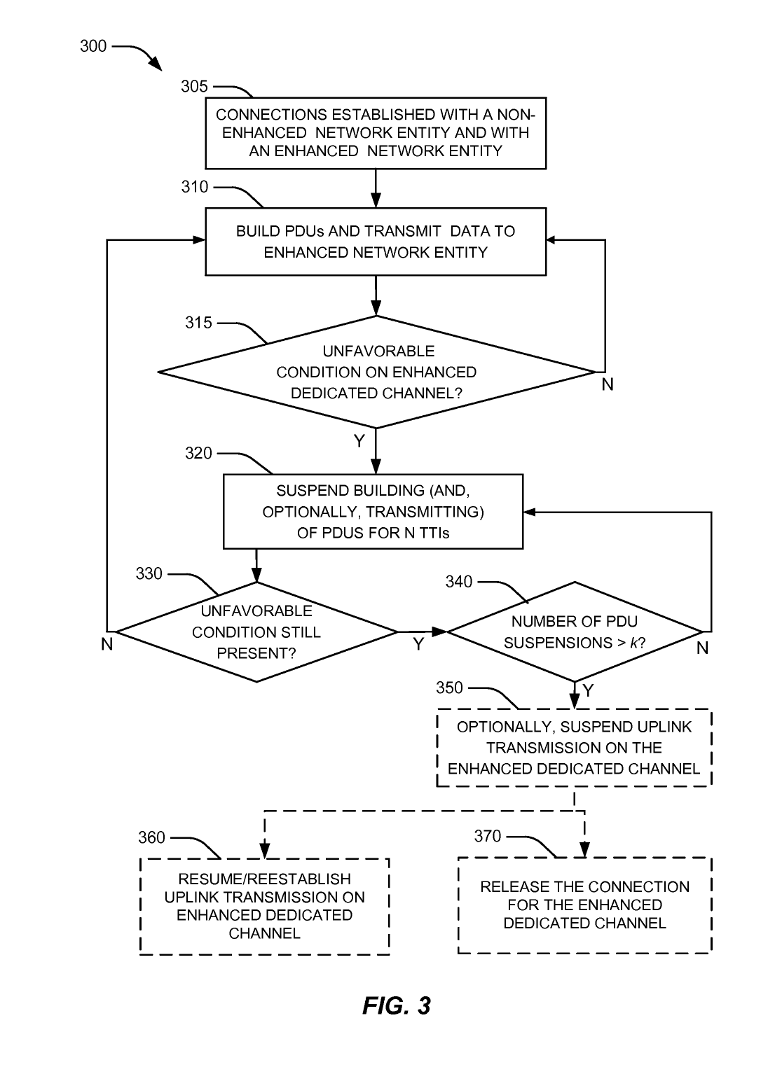

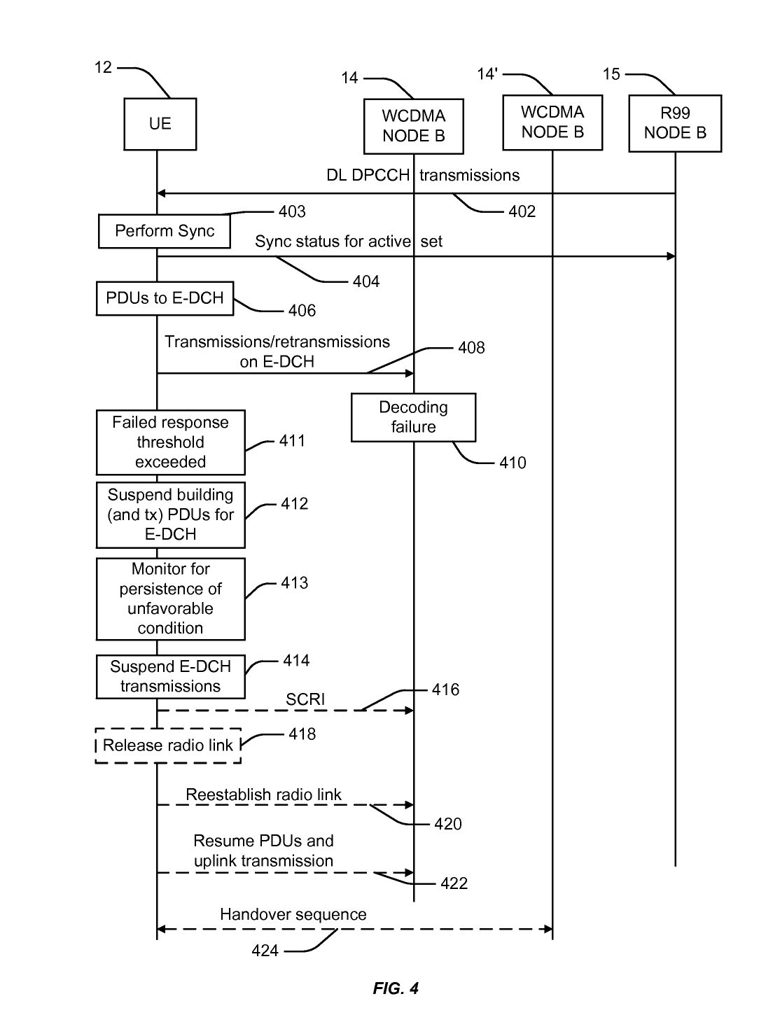

Referring to FIG. 3 and FIG. 4, in an operational aspect, a UE such as UE 12 (FIG. 1) may perform one aspect of a method 300 for controlling uplink transmissions on a dedicated channel, which is additionally described with reference to signal and state diagram illustrated in FIG. 4. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. In an aspect, method 300 may be implemented by UE 12 executing uplink control component 30 and/or one or more of its sub-components as described herein.

Method 300 involves UE 12 having a first connection established with a non-enhanced network entity 15, and a second connection established on an enhanced channel with enhanced network entity 14. After determining that the second connection is synchronized based on signals received via the first connection, UE 12 detects that the network is not able to decode uplink transmissions and/or retransmissions on a dedicated uplink channel, which may be caused by various conditions including, but not limited to, a weak wireless channel between UE 12 and enhanced network entity 14, despite the presence of a wireless channel of sufficient quality between UE 12 and the serving network entity, e.g., non-enhanced network entity 15. In one example, UE 12 may establish a first connection with non-enhanced network entity 15, receiving downlink transmissions, including, but not limited to DPCCH transmissions, perform a sync operation based on quality of the downlink channel, and respond with a sync status for the active set. UE 12 may also be connected to the only available enhanced network entity 14 in the active set (or any other enhanced network entities or cells in the active set may also have unfavorable channel conditions). To maintain an enhanced session with enhanced network entity 14, UE 12 may generate and send PDUs on an enhanced dedicated uplink transport channel (e.g., the E-DCH), carried by an enhanced dedicated uplink physical data channel (e.g., E-DPDCH). In a scenario where the channel condition of the connection with the non-enhanced network entity is strong enough to maintain uplink and downlink synchronization, while uplink transmissions to enhanced network entity 14 are failing (e.g., due to channel conditions such as interference or fading), method 300 includes steps to recover from this condition. In this case, the enhanced uplink dedicated channel may not be suitable for transmitting or receiving communications, but UE 12 can attempt to perform data retransmissions to enhanced network entity 14 on the basis of measurements of the quality of received downlink channel transmissions with non-enhanced network entity 15 acting as a serving cell for the active set. In this situation, according to the present aspects, rather than continuing to unsuccessfully send transmissions and/or retransmissions at continually higher transmit power levels, UE 12 may temporarily suspend building and encoding of PDUs for uplink transmission on the enhanced uplink dedicated channel, and/or may suspend transmitting the uplink transmissions on the enhanced uplink dedicated channel, to conserve processing and/or battery resources of the UE 12. Further, in an aspect, UE 12 may later restore such transmissions and/or retransmissions in case the uplink channel conditions have improved, or UE 12 may release the uplink channel connection to the enhanced network entity if failures on the uplink channel persist.

More specifically, in an aspect, for example, at block 305, the method 300 may include UE 12 having a first established connection, with non-enhanced network entity 15 and having a second established connection with enhanced network entity 14. In an aspect, the downlink and uplink synchronization of the second established connection with enhanced network entity 14 may be determined based on sufficient received signal quality from signals received from non-enhanced network entity 15 via first established connection, as discussed above. For instance, in one aspect, UE 12 may execute RRC connection component 36 to establish the connections with non-enhanced network entity 15 and enhanced network entity 14, such as via procedures associated with established communication protocols, such as those published by the 3GPP. Further, for example, referring to the example message flow of FIG. 4, downlink and uplink synchronization 403 may be established based on downlink DPCCH transmissions 402, and a sync status message 404 may be sent from UE 12 to non-enhanced network entity 15.

Also, at block 310, for example, the method 300 may include UE 12 building PDUs and transmitting the PDUs over an enhanced dedicated channel associated with the established connection with enhanced network entity 14. For instance, in one aspect, UE 12 and/or uplink control component 30 and/or PDU component 34 may build the PDUs, and uplink retransmission component 32 may manage transmission of the PDUs based on control signaling with transceiver 60. For instance, the PDUs may be constructed from data generated by one or more applications that may be being executed by application processor 42 (FIG. 2), and PDU component 34 may include a medium access control (MAC) layer protocol entity responsible for receiving logical flows of data packets and assembling the data packets into PDUs for transmission over one or more physical channels, such as E-DCH or E-PDPCH. Further, for example, referring to the example message flow of FIG. 4, UE 12 may build PDUs for transmission 406 on the enhanced dedicated channel, e.g., on the E-DCH or E-PDPCH, and transmit and/or retransmit such PDUs 408 on the enhanced dedicated channel.

In an aspect, at block 315, the method 300 may include determining an unfavorable condition of an enhanced dedicated channel in response to failing to receive a response corresponding to transmissions on the enhanced dedicated channel, with a number of failed responses exceeding a threshold, during an established session with at least one legacy network entity. For example, in an aspect, UE 12 and/or uplink control component 30 and/or uplink retransmission component 32 may determine an unfavorable condition on enhanced uplink channel 22 in response to failing to receive and/or decode a response corresponding to HARQ transmissions on the enhanced dedicated channel, with the number of failed responses exceeding a threshold. For example, in an aspect, UE 12 and/or uplink control component 30 and/or uplink retransmission component 32 may monitor an enhanced downlink channel 25 (e.g., E-HICH) and fail to detect or decode either ACK or NAK indications in response to uplink transmissions or retransmissions 24, either during a predefined interval (e.g., a transmission time interval, such as but not limited to 40 ms) and/or for a consecutive number of transmissions and/or retransmissions that meet a threshold. In other words, for example, UE 12 and/or uplink control component 30 and/or uplink retransmission component 32 may count a number of transmissions and/or retransmissions, and may count a number of corresponding acknowledgements, and then make a comparison to determine a number of unacknowledged transmissions. Then, for example, UE 12 and/or uplink control component 30 and/or uplink retransmission component 32 may compare the number of unacknowledged transmissions to a failed response threshold. Based on a condition where the number of unacknowledged transmissions exceeds the failed response threshold, the UE 12 and/or uplink control component 30 and/or uplink retransmission component 32 may determine that an unfavorable channel condition (e.g., out-of-sync) exists for enhanced uplink channel 22, and UE 12 may deduce that transmissions and/or retransmissions 24 are not being received and/or are not be properly decoded by enhanced network entity 14. In the example message flow of FIG. 4, at 406, UE 12 via PDU component 32, which may be a medium access control (MAC) entity of UE 12, may build and forward PDUs to transceiver 60 for transmission on an enhanced transport channel, e.g., E-DCH. And, at 408, UE 12 via transceiver 60, e.g., controlled by uplink control component 30 and/or uplink retransmission component 32, may transmit the PDUs on an enhanced dedicated physical channel 408.

At block 315, if no unfavorable condition is detected, then method 300 returns to block 310 and UE 12 continues to build and transmit PDUs on the enhanced dedicated channel.

If the presence of an unfavorable condition of an enhanced dedicated channel is determined in block 315, then in one aspect at block 320, the method 300 may include temporarily suspending the building of PDUs for an enhanced dedicated channel transmissions for a period of N transmission time intervals (TTIs), and optionally may suspend the transmitting of PDUs on the enhanced dedicated channel. In an aspect, for example, UE 12 and/or uplink control component 30 and/or PDU component 34 (FIG. 1) may suspend building of PDUs for and/or transmitting of PDUs on enhanced uplink channel 22, since it has been deduced in block 315 that the uplink transmissions 24 are either not being received or are not being properly decoded at the enhanced network entity 14, or that received responses from enhanced network entity 14 are not able to be correctly decoded. In the example message flow of FIG. 4, at 410, enhanced network entity 14 may fail to decode the uplink transmission 410 on the E-DCH. At 411, UE 12 and/or uplink control component 30 and/or PDU component 34 (FIG. 1) may detect the decoding failure at network entity 14 with respect to E-DCH transmissions based on determining that a response threshold of unacknowledged transmissions has been reached, e.g., based on tracking that a number or count of unacknowledged HARQ transmissions (e.g., retransmission failures) on the E-DCH have reached a defined threshold, or that a threshold duration of n TTIs (where n can be any positive number) over which transmissions on the E-DCH have not been acknowledged has expired. In an aspect, the response threshold may be set to a value that triggers the next remedial steps sooner than a normal HARQ failure according to 3GPP specifications, thereby resulting in a solution that uses less UE and network resources. In response, at 412, UE 12 via the uplink control component 30 may suspend building of PDUs for E-DCH transmission and/or suspend transmitting PDUs on the E-DCH, such as suspending for N TTIs, where N may be a positive integer.

At 330, following the suspension for N TTIs, the method 300 may include determining whether the unfavorable condition on the enhanced dedicated channel is still present. For example, in an aspect, UE 12 and/or uplink control component 30 and/or uplink retransmission component 32 may monitor enhanced downlink channel 25 to determine if the unfavorable condition of the enhanced downlink channel is still present. For instance, during the suspension of building and/or transmitting PDUs on enhanced uplink channel 22, UE 12 and/or uplink control component 30 and/or uplink retransmission component 32 may continue monitoring for receipt of responses from enhanced network entity 14 with respect to uplink data transmissions/retransmissions on enhanced uplink channel 22. As such, if UE 12 and/or uplink control component 30 and/or uplink retransmission component 32 may continue to identify a threshold number of unacknowledged transmissions, then the continuing of the unfavorable condition of enhanced uplink channel 22 may be identified. On the other hand, if UE 12 and/or uplink control component 30 and/or uplink retransmission component 32 does not continue to identify a threshold number of unacknowledged transmissions, then an end of the unfavorable condition of enhanced uplink channel 22 may be identified. Further, for example, in the example message flow diagram of FIG. 4, at 413, UE 12 and/or uplink control component 30 and/or uplink retransmission component 32 monitor whether or not the unfavorable condition on the E-DCH persists, such as determining whether or not any acknowledgements are received for previously sent or newly transmitted uplink data transmissions on the E-DCH.

If the condition of the enhanced dedicated channel has improved and the threshold(s) for unfavorable condition have been satisfied, as determined at block 330, then method 300 returns to block 310 and method 300 repeats from there. Also, referring to the example message flow of FIG. 4, the flow would transition from the monitoring at 413 to the building of PDUs at 406 and transmitting of the PDUs at 408.

If the unfavorable condition is still present, as determined at block 330, then the method 300 includes again suspending the building (and, optionally, transmitting) of PDUs with respect to the enhanced dedicated channel for N TTIs at block 320, if there have not already been more than k such suspensions as determined at block 340. For example, in an aspect, UE 12 and/or uplink control component 30 and/or uplink retransmission component 32 may continue to identify a threshold number of unacknowledged transmissions, and thus identify the continuing of the unfavorable condition of enhanced uplink channel 22. Then, UE 12 and/or uplink control component 30 and/or uplink retransmission component 32 may increment a count of a number of suspensions, N, and compare the count N to a threshold, k. In one aspect, the value N may be configurable depending on which of k cycles of suspensions is being performed. For example, N may be incremented with each suspension cycle, or N may be decremented with each suspension cycle, depending on a particular implementation. In an alternative aspect, N may remain fixed at a predetermined value. As such, UE 12 and/or uplink control component 30 and/or uplink retransmission component 32 may perform another suspension of building and/or transmitting PDUs for enhanced uplink channel 22 as described above, e.g., when N is not equal to k, or may take a next remedial action (see block 350 and beyond). Also, referring to the example message flow of FIG. 4, the flow would transition from the monitoring at 413 back to the suspending at 412, e.g., when N is not equal to k, or may take a next remedial action (see the suspending at 414 and beyond).

At block 350, the method 300 may optionally (as indicated by dashed lines) include suspending uplink transmissions (including retransmissions) on an enhanced dedicated channel in response the count of cycles for suspending PDUs (at block 320) exceeding threshold k (at block 340), such as when the suspending at block 320 only includes suspending building of the PDUs. In an aspect, for example, UE 12 and/or uplink control component 30 and/or PDU component 34 (FIG. 1) and/or one or more transceivers 60 may suspend uplink transmissions (including retransmissions) on enhanced uplink channel 22, e.g., E-DCH, in response to the unfavorable channel condition determined in block 310. In the example message flow of FIG. 4, at 414, UE 12 suspends uplink transmissions on enhanced dedicated channel in response to an exceeded count threshold at 412 following decoding failure at 410.

In an optional aspect (as indicated by dashed lines), at block 360, the method 300 may include resuming uplink transmission on an enhanced dedicated channel in response to detecting improved channel condition based on the monitoring of feedback on the enhanced downlink channel 25. In an aspect, for example, in a time period between first determining the unfavorable condition of enhanced uplink channel 22 (e.g., after detecting a consecutive number of unacknowledged retransmissions) and an unfavorable condition threshold (e.g., when the UE 12 will release the connection), the UE 12 and/or uplink control component 30 and/or uplink retransmission component 32 may detect ACK indications in response to the uplink transmissions or retransmissions 24, thereby indicating improved channel conditions, and may resume uplink transmission on the enhanced uplink channel 22 with the enhanced network entity 14. Resumption of PDUs to E-DCH and uplink transmission upon restored channel condition is shown in FIG. 4 by example message flow 422.

In another optional aspect (as indicated by dashed lines), at block 370, the method 300 may include releasing a connection to the enhanced dedicated channel when the unfavorable condition persists for a duration that meets an unfavorable condition threshold. For example, in an aspect, UE 12 and/or uplink control component 30 and/or RRC connection component 36 (FIG. 1) may send a SCRI (see message 417 in FIG. 4) to enhanced network entity 14 to release the radio link connection (see 418 in FIG. 4) associated with enhanced dedicated channel to preserve battery resources, e.g., after determining that the unfavorable condition persists for a duration that meets an unfavorable condition threshold. For instance, in an aspect, UE 12 and/or uplink control component 30 and/or RRC connection component 36 (FIG. 1) may identify a time duration corresponding to the suspending of building and/or transmitting PDUs associated with enhanced dedicated channel, and may compare the suspension time duration to a value of the unfavorable condition threshold. When the time duration corresponding to the suspending of building and/or transmitting PDUs associated with enhanced dedicated channel, and may compare the suspension time duration to a exceeds the value of the unfavorable condition threshold, then UE 12 and/or uplink control component 30 and/or RRC connection component 36 (FIG. 1) may send SCRI and release the corresponding connection.

Subsequently, for example, the UE 12 may attempt reestablish a connection with the same serving enhanced network entity 14 and reattempt enhanced uplink transmissions. For example, uplink control component 30 and/or RRC connection component 36 may reestablish connection with enhanced network entity 14, as shown by example message flow 420, for instance, such as based on one or more re-establishment procedures as published by 3GPP. Uplink transmission may be resumed (422) in response to the reestablished radio link 420.

In another aspect, upper layer component 38 may establish a link with enhanced network entity 14′ upon detecting a change to the active set 17 with the addition of enhanced network entity 14′. For example, upper layer component 38 may initiate a handover sequence with enhanced network entity 14′ to establish a new enhanced dedicated channel, as shown by the example message flow 424.

It should be noted that the method 300 may be performed for a UE 12 implementing multiple carrier transmission, such as a dual carrier UE. For example, UE 12 may transmit data and control signaling on two or more RF carriers. Accordingly, method 300 may be performed individually on each of the uplink RF carriers to resolve failure of uplink transmissions and retransmissions, where each RF carrier is assigned to a respective active set.

Method 300 may also be performed in a UE 12 configured as a multi-SIM multi-radio access technology (RAT) (MsMx) device, in which multiple SIM cards are available, each for a respective radio access technology (e.g., GSM, WCDMA, LTE, etc.) that may differ from the others. Method 300 enables the UE 12 to tune back to an enhanced serving cell that may have uplink dedicated channel in an unfavorable condition.

Method 300 may also be performed for a UE 12 that is grant limited due to network interference. For example, in a congested cell condition, where uplink grants must be limited by the network to avoid transmission errors, the network benefits from UE 12 performing method 300 since high power transmission/retransmission from UE 12 is reduced once UE 12 determines the unfavorable condition, which reduces the contribution by UE 12 to the cell interference.

In another aspect, for example in one use case, once a legacy downlink and uplink synchronization (e.g., an in-sync determination) is established, the UE 12 may continue to monitor the enhanced dedicated channel transmissions and enhanced downlink decoding status (e.g., indicators on an enhanced HARQ Indicator Channel (E-HICH)). When channel condition for enhanced uplink capable cell(s) in the active set of the UE 12 becomes degraded or poor (e.g., an indication of unacknowledged HARQ transmissions continuously for a threshold time and fails the enhanced dedicated channel synchronization primitives, the following remedial measures may be performed by the UE 12. The PDU building for enhanced dedicated channel transmission is ceased based on a history of the enhanced dedicated channel transmissions during a threshold amount of time (e.g., a number of TTIs), or based on previous HARQs for a threshold amount of time (e.g., X TTIs). After a threshold period of time (e.g., X TTIs) of such occurrences of stopping PDU building for enhanced dedicated channel transmissions, the UE 12 may send an SCRI (UE trigged) to the network to stop enhanced dedicated channel transmission, as the network does not initiate a serving cell change for a good PSC where enhanced uplink transmission and enhanced downlink decoding are continuously failing. Thus, a dedicated synchronization procedure is established for enhanced dedicated channel transmissions along with legacy dedicated physical channel synchronization.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may be stored on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f), unless the element is expressly recited using the phrase “means for” or, in the case of a method claim, the element is recited using the phrase “step for.”

What is claimed is:

1. A method of a user equipment controlling uplink transmissions on an enhanced dedicated channel in wireless communications, comprising:
determining an unfavorable condition of an enhanced dedicated channel established with an enhanced network entity in response to failing to receive a response corresponding to uplink data transmissions on the enhanced dedicated channel, wherein a number of failed responses exceeds a threshold, during an established connection with at least one non-enhanced network entity;
suspending building of protocol data units for enhanced dedicated channel transmissions in response to determining the unfavorable condition of the enhanced dedicated channel; and
suspending uplink transmission on the enhanced dedicated channel in response to determining the unfavorable condition of the enhanced dedicated channel.

2. The method of claim 1, wherein determining the unfavorable condition is based on a count of a number of continuous uplink data transmissions and/or uplink data retransmissions unacknowledged by a response and comparing the count to the threshold.

3. The method of claim 1, further comprising:
determining that a duration of the unfavorable condition of the enhanced dedicated channel has reached an unfavorable condition threshold; and
sending a connection release indicator for the enhanced dedicated channel to a serving network entity in response to determining the duration has reached the unfavorable condition threshold.

4. The method of claim 1, further comprising:
determining, prior to a duration of the unfavorable condition of the enhanced dedicated channel reaching an unfavorable condition threshold, that the unfavorable condition of the enhanced dedicated channel has improved based on further monitoring for the response;
resuming the building of the protocol data units for the enhanced dedicated channel; and
resuming the uplink transmission on the enhanced dedicated channel in response to the determination of the improved condition.

5. The method of claim 1, further comprising:
receiving an indication that a new network entity has been added to an active set of the UE, the new network entity being enabled to receive the uplink data transmissions on the enhanced dedicated channel;
performing handover to the new network entity; and
resuming the uplink data transmissions on the enhanced dedicated channel with the new network entity.

6. The method of claim 1, wherein the suspending further comprises suspending the uplink data transmissions and/or uplink data retransmissions on the enhanced dedicated channel.

7. A user equipment (UE) for controlling uplink transmissions on an enhanced dedicated channel in wireless communications, comprising:
means for determining an unfavorable condition of an enhanced dedicated channel established with an enhanced network entity in response to failing to receive a response corresponding to uplink data transmissions on the enhanced dedicated channel, wherein a number of failed responses exceeds a threshold, during an established connection with at least one non-enhanced network entity;
means for suspending building of protocol data units for enhanced dedicated channel transmissions in response to determining the unfavorable condition of the enhanced dedicated channel; and
means for suspending uplink transmission on the enhanced dedicated channel in response to determining the unfavorable condition of the enhanced dedicated channel.

8. The UE of claim 7, wherein the means for determining the unfavorable condition is determines the unfavorable condition based on counting a threshold number of continuous uplink data transmissions and/or uplink data retransmissions unacknowledged by a response.

9. The UE of claim 7, further comprising:
means for determining that a duration of the unfavorable condition of the enhanced dedicated channel has reached an unfavorable condition threshold; and
means for sending a connection release indicator for the enhanced dedicated channel to a serving network entity in response to determining the duration has reached the unfavorable condition threshold.

10. The UE of claim 7, further comprising:
means for determining, prior to a duration of the unfavorable condition of the enhanced dedicated channel reaching an unfavorable condition threshold, that the unfavorable condition of the enhanced dedicated channel has improved based on further monitoring for the response;
means for resuming building of the protocol data units for the enhanced dedicated channel; and
means for resuming the uplink data transmissions on the enhanced dedicated channel.

11. The UE of claim 7, further comprising:
means for receiving an indication that a new network entity has been added to an active set of the UE, the new network entity being enabled to receive the uplink data transmissions on an enhanced dedicated channel;
means for performing handover to the new network entity; and
means for resuming the uplink transmissions on the enhanced dedicated channel with the new network entity.

12. The UE of claim 7, wherein the means for suspending uplink transmission suspends the uplink data transmissions and/or uplink data retransmissions on the enhanced dedicated channel.

13. A user equipment (UE) for controlling uplink transmissions on an enhanced dedicated channel in wireless communications, comprising:
a transceiver configured to transmit uplink data transmissions on the enhanced dedicated channel, and to receive responses corresponding to the uplink data transmissions; and
at least one processor coupled to the transceiver via a bus, the at least one processor configured to:
determine an unfavorable condition of an enhanced dedicated channel in response to the transceiver failing to receive a response corresponding to the uplink data transmissions on the enhanced dedicated channel, wherein a number of failed responses exceeds a threshold, during an established connection with at least one non-enhanced network entity;
suspend building of protocol data units for enhanced dedicated channel transmissions in response to determining the unfavorable condition of the enhanced dedicated channel; and
suspend the uplink data transmissions by the transceiver on the enhanced dedicated channel in response to determining the unfavorable condition of the enhanced dedicated channel.

14. The UE of claim 13, further comprising:
an antenna; and
a radio frequency (RF) front end coupled to the antenna and to the transceiver, the RF front end configured to transmit the uplink data transmissions on the enhanced dedicated channel via the antenna to an enhanced network entity and to receive, via the antenna, the responses to the uplink data transmissions; and
wherein the at least one processor is further configured to determine the unfavorable condition based on a count of a number of continuous uplink data transmissions and/or uplink data retransmissions unacknowledged by a response and comparing the count to the threshold.

15. The UE of claim 13, wherein the at least one processor is further configured to determine that a duration of the unfavorable condition of the enhanced dedicated channel has reached an unfavorable condition threshold; and
the transceiver is further configured to send a connection release indicator for the enhanced dedicated channel to a serving network entity in response to determining the duration has reached the unfavorable condition threshold.

16. The UE of claim 13, wherein:
the at least on processor is further configured to:
determine, prior to a duration of the unfavorable condition of the enhanced dedicated channel reaching an unfavorable condition threshold, that the unfavorable condition of the enhanced dedicated channel has improved based on further monitoring for the responses;
resume building of the protocol data units for the enhanced dedicated channel in response to the determination of the improved condition; and
the transceiver is further configured to resume the uplink transmissions on the enhanced dedicated channel in response to the determination of the improved condition.

17. The UE of claim 13, wherein the at least one processor is further configured to receive indication that a new network entity has been added to an active set of the UE, the new network entity being enabled to receive the uplink data transmissions on an enhanced dedicated channel, and to perform handover to the new network entity; and
wherein the transceiver is further configured to resume the uplink data transmissions on the enhanced dedicated channel with the new network entity.

18. The UE of claim 13, wherein the at least one processor is further configured to suspend the uplink data transmissions and/or uplink data retransmissions on the enhanced dedicated channel.

19. The UE of claim 13, further comprising a memory coupled to the at least one processor configured to store a count of continuous transmissions on the enhanced dedicated channel to which no response was received by the transceiver.

20. The UE of claim 13, further comprising a memory coupled to the at least one processor configured to store a count of a number of transmission time intervals exceeding a count threshold, wherein the at least one processor is further configured to determine the unfavorable condition of the enhanced dedicated channel in response to determining that the count of the number of transmission time intervals exceeds a count threshold.

21. The UE of claim 13, wherein the at least one processor comprises a modem baseband processor, and wherein the modem baseband processor is further configured to:
establish a first communication connection defining the established connection with the at least one non-enhanced network entity;
establish a second communication connection, including the enhanced dedicated channel, with an enhanced network entity;
apply a hybrid automatic repeat request (HARQ) scheme for the transmissions on the enhanced dedicated channel; and
wherein the at least one processor determines the unfavorable condition of the enhanced dedicated channel further in response to detecting a count of unacknowledged HARQ transmissions exceeding the threshold.

22. The UE of claim 21, wherein the modem baseband processor is further configured to:
estimate a channel quality of a received downlink physical channel from the at least one non-enhanced network entity;
compare the estimated channel quality to one or more quality thresholds; and
report an in-sync condition indicating that the estimated channel quality meets or exceeds the one or more quality thresholds.

23. A computer-readable medium storing computer executable code for controlling uplink transmissions on an enhanced dedicated channel in wireless communications, comprising:
code for determining an unfavorable condition of an enhanced dedicated channel established with an enhanced network entity in response to failing to receive a response corresponding to uplink data transmissions on the enhanced dedicated channel, wherein a number of failed responses exceeds a threshold, during an established connection with at least one non-enhanced network entity;
code for suspending building of protocol data units for enhanced dedicated channel transmissions in response to determining the unfavorable condition of the enhanced dedicated channel; and
code for suspending uplink transmission on the enhanced dedicated channel in response to determining the unfavorable condition of the enhanced dedicated channel.

24. The computer-readable medium of claim 23, wherein code for determining the unfavorable condition is based on a count of a number of continuous uplink data transmissions and/or uplink data retransmissions unacknowledged by a response and comparing the count to the threshold.

25. The computer-readable medium of claim 23, further comprising:
code for determining that a duration of the unfavorable condition of the enhanced dedicated channel has reached an unfavorable condition threshold; and
code for sending a connection release indicator for the enhanced dedicated channel to a serving network entity in response to determining the duration has reached the unfavorable condition threshold.

26. The computer-readable medium of claim 23, further comprising:
code for determining, prior to a duration of the unfavorable condition of the enhanced dedicated channel reaching an unfavorable condition threshold, that the unfavorable condition of the enhanced dedicated channel has improved based on further monitoring for the response;
code for resuming the building of the protocol data units for the enhanced dedicated channel; and
code for resuming the uplink data transmissions on the enhanced dedicated channel.

27. The computer-readable medium of claim 23, further comprising:
code for receiving an indication that a new network entity has been added to an active set of the UE, the new network entity being enabled to receive the uplink data transmissions on an enhanced dedicated channel;
code for performing handover to the new network entity; and
code for resuming the uplink transmission on the enhanced dedicated channel with the new network entity.

28. The computer-readable medium of claim 23, wherein the code for suspending further comprises suspending the uplink data transmissions and/or uplink data retransmissions on the enhanced dedicated channel.
